(19) United States
(12) Patent Application Publication
(10) Pub. No.: US 2010/0317217 A1
(43) Pub. Date: Dec. 16, 2010

(54) CABLE ASSEMBLY WITH LATCHING MEMBER

(75) Inventors: SHI-QUAN CHEN, Shenzhen (CN); ZHU-QUAN XIAN, Shenzhen (CN); HUA-YING LIU, Shenzhen (CN); CHUNG-YEN YANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/815,427

(22) Filed: Jun. 15, 2010

(30) Foreign Application Priority Data
Jun. 16, 2009 (CN) 200920304477.3

(51) Int. Cl. H01R 13/62

(52) U.S. Cl. 439/345

(57) ABSTRACT

A cable assembly (100) includes a connector; a cable connected to the connector; a cover having a plurality of walls interconnected with each other to form a receiving space, the connector accommodated in receiving space; at least one latching member unitarily formed with a side wall of the cover, the latching member having a deformable latching arm connected with a back section of the side wall and a supporting arm connected with the latching arm and the side wall, and the latching arm further having a hook formed at a front end thereof.

### FIELD OF THE INVENTION

The present invention generally relates to a cable assembly, and more particular to a cable assembly with an improved latching member.

### DESCRIPTION OF PRIOR ART

Many electrical connectors include latch means for securely but releasably retaining a pair of electrical connector housings in a mated condition. More particularly, these prior art connectors include mateable pairs of molded plastic housings, each of which is constructed to receive a plurality of terminals therein. The terminals of one housing electrically contact the terminals of the other housing when the housings are in their mated condition.

Unitarily molded electrical connector housings are generally considered desirable in that they yield certain manufacturing efficiencies, simplify the installation and use of the connector and minimize inventory management problems. Thus, it is often desirable to unitarily mold an entire electrical connector housing, including the latch means thereof.

Many electrical connectors are used in environments where they will be repeatedly connected and disconnected by personnel having relatively little familiarity with the mechanics and intended use of the connector. For example, electrical connectors often are employed in photostatic copiers and other office equipment that may periodically be serviced by field technicians or by the office staff that uses the copier or other such business machine. Field technicians often are not adequately trained on the proper usage of every electrical connector they are likely to encounter. Office personnel using various business machines typically have even less training and familiarity with the electrical connectors they may periodically be required to connect and/or disconnect. This lack of familiarity with the electrical connectors manipulated by field or office personnel can result in overstressing the latch mechanisms employed to lockingly but releasably retain electrical connector housings in a mated condition. For example, inexperienced field personnel may unintentionally bias a latch mechanism too far, thereby breaking or reducing the effectiveness of the latch.

Electrical connector housings have been developed to minimize this potential for overstressing the latch structures thereof For example, U.S. Pat. No. 4,462,654 which issued to Aiello on Jul. 31, 1984 shows a latch integrally and pivotally connected to a housing. The forward end of the latch extends from the pivoted connection to define a latch portion which is engageable with corresponding structure on a mateable housing. The rearward end of the latch member extends in the opposite direction from the pivot and includes an overstress stop which is pivotable into a lug or wall on the electrical connector housing. Contact between the overstress stop and the lug or wall of the electrical connector housing is intended to limit the amount of rotation around the pivot point during the normal engagement of the electrical connector housings. Although this construction may control the amount of pivoting during proper use of the electrical connector, it provides no positive anti-stress protection adjacent the forward end of the latch member. Thus, field personnel inexperienced with the intended operation of the latch shown in U.S. Pat. No. 4,462,654 could apply rotatable pressure to the forwardmost end of the latches for either locking or releasing the electrical connector housings to one another. Such rotational forces exerted on the forward end of the latch member could overstress the latch, thereby causing the latch to break or be of reduced effectiveness.

Hence, an improved latching member for cable assembly is highly desired to overcome the aforementioned problems.

### SUMMARY OF THE INVENTION

Accordingly, an object of the present invention is to provide a cable assembly with an improved latching member.

In order to achieve the object set forth, a cable assembly in accordance with the present invention comprises a connector; a cable connected to the connector; a cover having a plurality of walls interconnected with each other to form a receiving space, the connector accommodated in receiving space; at least one latching member unitarily formed with a side wall of the cover, the latching member having a deformable latching arm connected with a back section of the side wall and a supporting arm connected with the latching arm and the side wall, and the latching arm further having a hook formed at a front end thereof.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of the cable assembly in accordance with the present invention;

FIG. 2 is similar to FIG. 1, but viewed from another aspect;

FIG. 3 is an assembled view of the cable assembly; and

FIG. 4 is cross section view of the cable assembly taken along line 4-4.

### DETAILED DESCRIPTION OF PREFERRED EMBODIMENTS

Reference will now be made in detail to the preferred embodiment of the present invention.

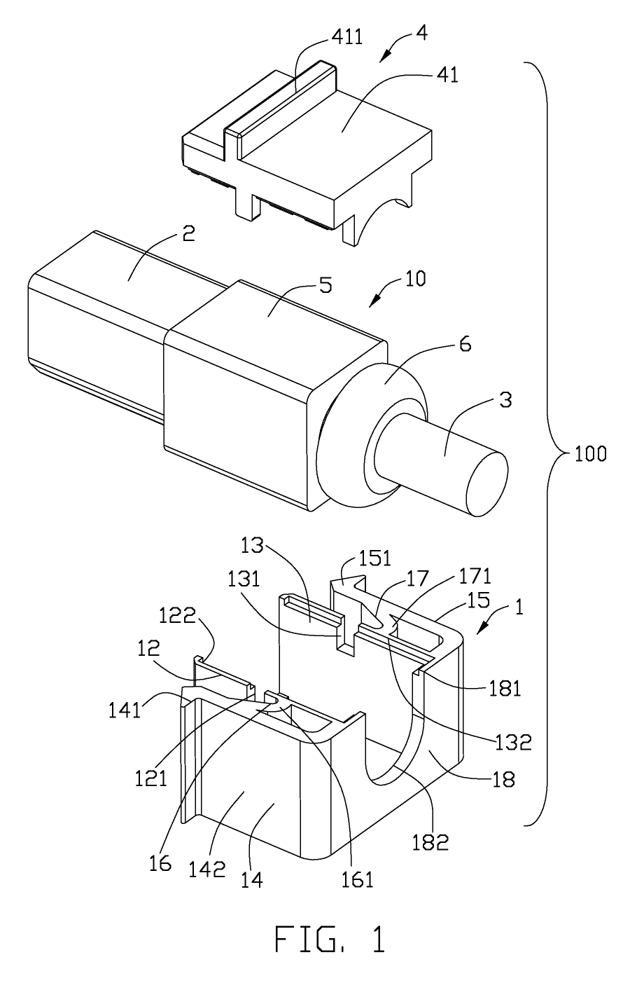

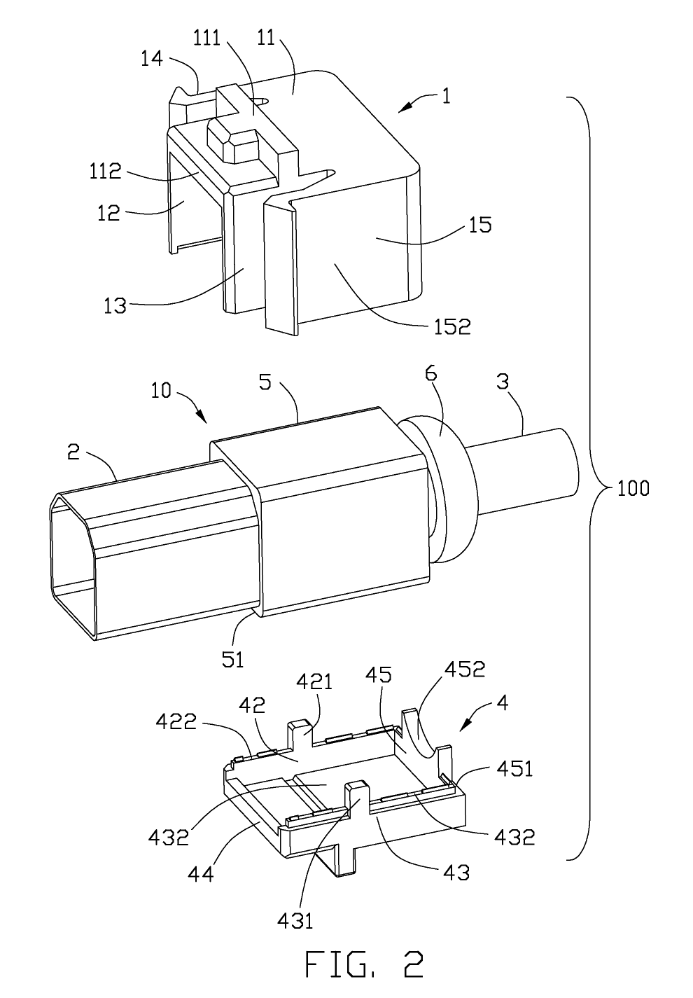

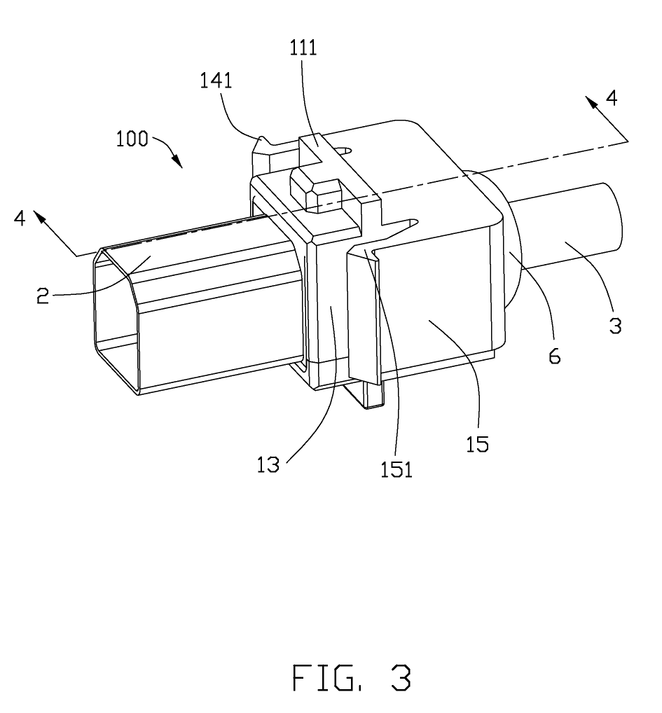

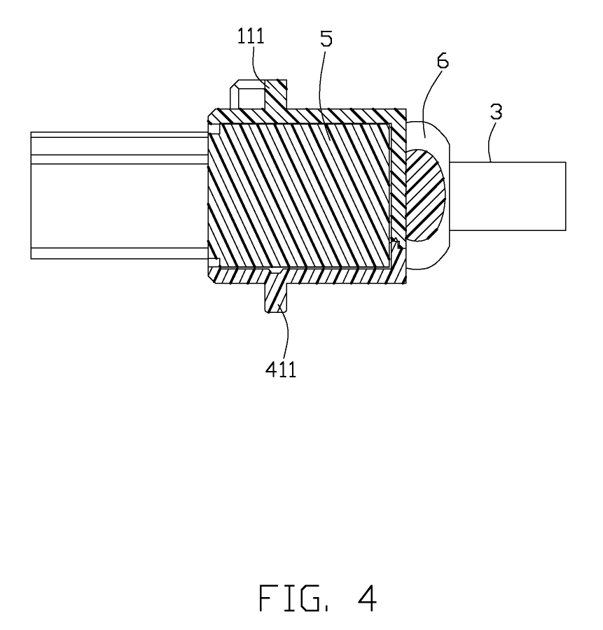

Referring to FIGS. 1-4, a cable assembly 100 in accordance with the present invention comprises a cover 1, a connector 2 accommodated in the cover 1, a cable 3 connected to the connector 2, a cap 4 assembled to the cover 1 and a retainer 5 molding onto a connecting area between the cable 3 and the connector 2, and an block 6 is formed on the cable 3 and spaced apart from the retainer 5.

The cover 1 includes a bottom wall 11, a first side wall 12 and a second side wall 13 and a back wall 18 formed on laterals edges and a back edge of the bottom wall 11. The aforementioned walls are interconnected with each other to form a receiving space.

A first latching member 14 and a second latching member 15 are respectively arranged outwardly and unitarily formed with the first and second side walls 11, 22. The first latching member 14 includes a deformable first latching arm 142 having a rear end connected to a back section of the first side wall 12, and an oblique first supporting arm 16 connecting middle section of the first side wall 12 and inner surface of the first latching arm 142. The first latching member 14 further has a hook 141 formed at a front end of the latching arm 142. The first supporting arm 16 further has an elbow 161 arranged at a back end thereof and located between the first side wall 12 and the first latching arm 142. The second latching member 15 includes a deformable second latching arm 152 having a rear end connected to a back section of the second side wall 13, and an oblique second supporting arm 17 connecting middle section of the second side wall 13 and inner surface of the second latching arm 152. The second latching member 15 further has a hook 151 formed at front end of the latching arm 152. The second supporting arm 17 further has an elbow 171 arranged at a back end thereof and located between the second side wall 12 and the second latching arm 152. The elbows 161, 171 can increase flexibility of the first supporting arm 16 and the second supporting arm 17, and not reduce robust supporting function thereof.

A T-shaped protrusion 111 is formed at a front section of an outer side of the bottom wall 11. A first stopper 112 is formed on a front end of the bottom wall 11. A first notch 122 is defined in a top section of an inner side of the first side wall 12. A first cutout 121 is defined in the first side wall 12 and located proximate to the first supporting arm 16. A second notch 132 is defined in a top section of an inner side of the second side wall 13. A second cutout 131 is defined in the first side wall 13 and located proximate to the second supporting arm 17. A third notch 181 is defined in a top section of an inner side of the back wall 18. A first outlet 182 is defined in a middle segment of the back wall 18.

The cap 4 includes a top wall 41, a first side wall 42 and a second side wall 43 and a back wall 45 formed on laterals edges and a back edge of the bottom wall 41. Two positioning post 421, 423 are formed at lower edges of the first side wall 42 and a second side wall 43, respectively. Three flanges 422, 432, 451 are formed on lower edges of the first side wall 42, the second side wall 43 and the back wall 45. A second outlet 452 is defined in a middle segment of the back wall 45. A transversal beam 411 is formed on front segment of an outer surface of the top wall 41. A second stopper 44 is formed on a front end of the top wall 41.

A rear segment of the connector 2 is accommodated inside and held by the cover 1 and the cap 4, and the retainer 5 is retained in a hollow 432 inside of the cap 4, and the block disposed behind the back walls 18 and 45. The positioning posts 421, 431 are inserted into the first cutout 121 and the second cutout 131, respectively. The flanges 422, 432, 451 are fitted into the first notch 122, the second notch 132 and the third notch 181, respectively. Some spaced tiny horizontal ribs (not labeled) formed on and along the edge of the flanges 422, 432, 451 may be used to join the cover 1 and the cap 4 together under a melting manner via an ultrasonic procedure. Thus, the cover 1 and the cap 4 are combined together.

When the cable assembly 100 mates with a complementary connector (not shown), the hooks 141, 151 are locked with the complementary connector. The first supporting arm 16 and the second supporting arm 17 may enhance the first latching member 14 and the second latching member 15.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable assembly, comprising:
a connector;
a cable connected to the connector;
a cover having a plurality of walls interconnected with each other to form a receiving space, the connector accommodated in the receiving space;
at least one latching member unitarily formed with a side wall of the cover, the latching member having a deformable latching arm connected with a back section of the side wall and a supporting arm connected with the latching arm and the side wall, and the latching arm further having a hook formed at a front end thereof.

2. The cable assembly as recited in claim 1, wherein the supporting arm connects a middle section of the side wall with an inner surface of the latching

3. The cable assembly as recited in claim 1, wherein the supporting arm obliquely and forwardly extends from the side wall.

4. The cable assembly as recited in claim 1, wherein the supporting arm has an elbow at a rear end thereof and disposed between the side wall and the latching arm.

5. The cable assembly as recited in claim 1, further comprising a cap assembled to the cover.

6. The cable assembly as recited in claim 5, wherein the cap has a plurality of walls interconnected together to form a hollow.

7. The cable assembly as recited in claim 6, wherein there is a retainer molding onto a connecting area between the cable and the connector, and the retainer is located in the hollow.

8. The cable assembly as recited in claim 6, wherein the cap has two positioning posts respectively formed on bottom edges of the walls thereof, and the cover has two cutouts respectively defined in the walls thereof to receive the positioning posts.

9. The cable assembly as recited in claim 6, wherein the cap has two flanges respectively formed on bottom edges of the walls thereof, and the cover has two notches respectively defined in the walls thereof to receive the flanges.

10. A cable assembly, comprising:
a connector;
a cable connected to the connector;
a cover holding the connector, the cover having a first side wall and a second side wall;
a first latching member including a deformable first latching arm having a rear end connected with the first side wall and a front end with a hook, a first supporting arm formed with the first side wall and extending forwardly and outwardly to support the first latching arm;
a second latching member including a deformable second latching arm having a rear end connected with the second side wall and a front end with a hook, a second supporting arm formed with the second side wall and extending forwardly and outwardly to support the second latching arm.

11. The cable assembly as recited in claim 10, wherein the first supporting arm is located between the first side wall and the first latching arm, and the second supporting arm is located between the second side wall and the second latching arm.

12. The cable assembly as recited in claim 11, wherein both the first supporting arm and the second supporting arm respectively have an elbow.

13. A cable connector assembly for use with a panel having opposite forward and rearward surfaces thereon with an opening extending therethrough, comprising:
a insulative cover and a cap fastened together as a case unit defining a hollow therein;
an electrical connector connected to a cable with a retainer enclosing a connection area between the connector and the cable, the retainer being dimensionally, in a cross-section, larger than the connector,
said case unit defining opposite top and bottom walls and opposite two side walls commonly forming said hollow communicating with exterior via a front opening;
a pair of opposite stoppers formed on front edges of either the opposite top and bottom walls or the opposite two side walls so as to abut against a front face of the retainer while allowing said connector to extend forwardly through said front opening;
opposite transversely extending protrusions formed on said opposite top and bottom walls for forwardly abutting against the rearward surface of the panel under condition that one of said protrusions further includes a portion extending in a front-to-back direction for orientation and alignment consideration with the panel; and
a pair of resilient latches each located transversely beside the corresponding side wall with a gap therebewteen so as to have each of said latches defines a rearward face for rearwardly abutting against the front surface of the panel under condition that the case unit with said pair of resilient latches and the forwardly extending connector are configured for being commonly received in the opening of said panel.

14. The cable connector assembly as claimed in claim 13, wherein each of said resilient latches is connected to the corresponding side wall at two spaced positions in said front-to-back direction.
